(19) United States
(12) Patent Application Publication
(10) Pub. No.: US 2009/0115828 A1
(43) Pub. Date: May 7, 2009

(54) RECORDING APPARATUS AND LIQUID EJECTING APPARATUS

(75) Inventor: Tsunenobu ENDO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/255,821

(22) Filed: Oct. 22, 2008

(30) Foreign Application Priority Data
Oct. 26, 2007 (JP) 2007-279650
Oct. 29, 2007 (JP) 2007-281008
Oct. 14, 2008 (JP) 2008-265482

(51) Int. Cl. B41J 2/01

(52) U.S. Cl. 347/102

(57) ABSTRACT

The present invention relates to an ink jet recording apparatus having an ultraviolet irradiation head having a discharge tube. Solving means include a recording head that reciprocates along the surface of recording paper and discharges ultraviolet curable ink toward the recording paper, a discharge tube that moves together with the recording head and outputs ultraviolet light, and a movable plane reflecting mirror that switches between two light paths through which ultraviolet light from the discharge tube is applied in front of and behind the recording head in the reciprocation direction M. The discharge tube may include an elliptic reflecting mirror that converges output ultraviolet light toward the surface of the recording paper.

### CROSS-REFERENCE TO RELATED APPLICATIONS

This application claims priority under the Paris Convention based on Japanese Patent Application No. 2007-281008 (filed on Oct. 29, 2007), Japanese Patent Application No. 2007-279650 (filed on Oct. 26, 2007), and Japanese Patent Application No. 2008-265482 (filed on Oct. 14, 2008).

### BACKGROUND OF THE INVENTION

The present invention relates to a recording apparatus and a liquid ejecting apparatus. More specifically, it relates to a recording apparatus and a liquid ejecting apparatus that use ultraviolet curable ink.

### DESCRIPTION OF THE RELATED ART

There is a recording apparatus or a liquid ejecting apparatus that forms an image on a recording medium using ultraviolet curable ink. Ultraviolet curable ink has the property of curing very slowly before the application of ultraviolet light and curing rapidly upon the application of ultraviolet light, so it is preferred as printing ink. In addition, it also has the advantage of being environment-friendly because the solvent is not volatilized and diffused in the process of curing.

Moreover, ultraviolet curable ink has a high adhesion property when the vehicle composition is appropriate, so resin films, metal foil, and so forth can be used as recording media. In addition, by forming a background layer or foundation layer using an ink with high hiding power, a clear image can be formed even on a transparent or deep color recording medium. Furthermore, after an image is formed with color inks, by coating the surface with a background color or transparent ink, the surface can be smoothed and the image can be protected. Although methods for attaching ultraviolet curable ink to a recording medium include coating and printing, the use of the ink jet method, by which any image or pattern can be formed without a plate, is expected.

The following Patent Document 1 describes an ink jet printer using ultraviolet curable ink. In this ink jet printer, an ultraviolet lamp adjacent to an ink jet head is mounted on a carrier (carriage), and ultraviolet light is applied to ultraviolet curable ink just attached to a recording medium. However, the ultraviolet lamp is disposed adjacent to the ink jet head in the transport direction of the recording medium, and so, after the ink jet head has scanned the width of the recording medium, ultraviolet light is applied to the region.

In addition, the following Patent Document 2 describes a recording apparatus having a structure in which a pair of ultraviolet lamps are mounted on a carriage together with an ink jet head, the lamps disposed on opposite sides of the ink jet head along the scanning direction of the carriage. Moreover, the following Patent Document 3 also describes a recording apparatus having ultraviolet irradiation sections disposed on opposite sides of a recording head in the scanning direction.

In these recording apparatuses, ultraviolet light is applied to ultraviolet curable ink just discharged from the recording head. In addition, since a pair of ultraviolet irradiation sections are disposed on opposite sides of the recording head in the scanning direction, ultraviolet light can be applied to ultraviolet curable ink just discharged from recording head in both the forward and backward movements of scanning.

### SUMMARY OF THE INVENTION

A discharge-tube-type ultraviolet lamp, such as a metal halide lamp, a xenon lamp, a carbon-arc lamp, a chemical lamp, a low-pressure mercury lamp, or a high-pressure mercury lamp, can be used as an ultraviolet light source in the ultraviolet irradiation section. This type of light source include a quartz glass tube in which a discharge atmosphere is sealed and a large insulating member that maintains a high voltage during lighting, so it is difficult to downsize it. For this reason, providing the recording head with a plurality of ultraviolet irradiation sections significantly increases the size of the recording apparatus.

In addition, when an LED is used as an ultraviolet light emitting element, many elements need to be mounted to achieve the required output. For this reason, as in the case of a discharge tube type, the downsizing of ultraviolet irradiation sections is difficult.

In addition, a high-power ultraviolet lamp capable of rapidly hardening ultraviolet curable ink is expensive. The use of LEDs can be more expensive than that of discharge-tube-type ultraviolet lamps because of the increase in the number of elements. For this reason, when a plurality of ultraviolet irradiation sections are provided, the increase in the cost of the recording apparatus is inevitable.

To solve the above problems, a recording apparatus including a recording head that reciprocates along the surface of a recording medium and discharges ultraviolet curable ink toward the recording medium, an ultraviolet light source that moves together with the recording head and outputs ultraviolet light, and a light path switching section that switches between two light paths through which ultraviolet light from the ultraviolet light source is applied in front of and behind the recording head in the reciprocation direction, is provided as a first aspect of the present invention. Since ultraviolet light can be applied to a plurality of irradiation objects with a single ultraviolet light source, the use efficiency of an ultraviolet light source can be improved. In addition, the power that the ultraviolet light source consumes can be reduced.

In the above recording apparatus, the light path switching section may includes a plane reflecting mirror that changes the propagation direction of output light of the ultraviolet light source by rotating around an axis perpendicular to the reciprocation direction. Thus, a recording apparatus having a simple structure and the above advantageous effects can be formed.

In the above recording apparatus, the light path switching section may include an elliptic reflecting mirror that has an elliptic arc cross-sectional shape, that is disposed in such a manner that the ultraviolet light source is located at one of the focal points, thereby converging the output light of the ultraviolet light source, and that rotates around an axis passing through said one of the focal points, thereby outputting the output light of the ultraviolet light source in different directions This reduces the number of components and contributes to the reduction in size and weight of the recording apparatus.

In the above recording apparatus, the two light paths may include a forward ultraviolet light path that follows the recording head in the forward movement of the reciprocation and guides ultraviolet light toward the ultraviolet curable ink attached to the recording medium, and a backward ultraviolet light path that follows the recording head in the backward movement of the reciprocation and guides ultraviolet light toward the ultraviolet curable ink attached to the recording medium, and the light path switching section may input the output light of the ultraviolet light source into the forward ultraviolet light path or the backward ultraviolet light path. Thus, ultraviolet curable ink can be hardened with a single ultraviolet light source in both the forward and backward movements of reciprocation of the recording head. So, the structure reciprocating together with the recording head can be reduced in size and weight, and the whole recording apparatus can be reduced in size and weight as well.

The above recording apparatus may further include a vibrating section that rocks at least part of the ultraviolet irradiation head. Since the curing speed of ultraviolet curable ink changes depending on the intensity of applied ultraviolet light, it is preferable that the irradiation intensity be uniform in the area irradiated by the ultraviolet irradiation head used to harden ultraviolet curable ink. If the intensity of ultraviolet light that the ultraviolet irradiation head applies is lacking in uniformity, the intensity can be uniformized by rocking the ultraviolet irradiation head.

The above recording apparatus may further include a vibrating section that periodically displaces parallel to an optical axis plane of the reflecting surface of the elliptic reflecting mirror, thereby rocking the elliptic reflecting mirror, at least part of the elliptic reflecting mirror, around an axis perpendicular to the optical axis plane. Similarly to the above, if the intensity of ultraviolet light that the ultraviolet irradiation head applies is lacking in uniformity, the intensity can be uniformized by rocking the ultraviolet irradiation head.

In the above recording apparatus, the vibrating section may include a linear actuator that linearly displaces part of the reflecting mirror rotatably supported at another part thereof. Thus, the irradiation intensity distribution can be uniformized with a simple structure.

In the above recording apparatus, the light path switching section may include an aluminum plate having a mirrored surface. Thus, ultraviolet light can be efficiently reflected and applied to the irradiation object at a low cost.

In the above recording apparatus, the elliptic reflecting mirror may be rotatably supported around an axis that is a straight line passing through the center of gravity of the elliptic reflecting mirror, and the vibrating section may rock the elliptic reflecting mirror around the axis. Since the center of gravity of the reflecting mirror does not move in spite of rocking, the vibration caused by the rocking of the reflecting mirror is controlled. In addition, the drive power requirement of the actuator is not increased.

In the above recording apparatus, the light path switching section may include a forward reflecting mirror that follows the recording head in the forward movement of the reciprocation and guides ultraviolet light toward the ultraviolet curable ink attached to the recording medium, a backward reflecting mirror that follows the recording head in the backward movement of the reciprocation and guides ultraviolet light toward the ultraviolet curable ink attached to the recording medium, and a vibrating section that rocks at least one of the forward reflecting mirror and the backward reflecting mirror. Also in such a configuration including a forward reflecting mirror, a backward reflecting mirror, and a vibrating section, if the intensity of ultraviolet light that the ultraviolet irradiation head applies is lacking in uniformity, the intensity can be uniformized by changing the propagation direction of ultraviolet light by rocking the forward reflecting mirror and the backward reflecting mirror.

A liquid ejecting apparatus including a liquid ejecting head that reciprocates along the surface of an ejecting medium and discharges liquid including ultraviolet curable resin toward the ejecting medium, an ultraviolet light source that moves together with the liquid ejecting head and outputs ultraviolet light, and a light path switching section that switches between two light paths through which ultraviolet light from the ultraviolet light source is applied in front of and behind the liquid ejecting head in the reciprocation direction, is provided as a second aspect of the present invention. Thus, also in a liquid ejecting apparatus, the above effects can be enjoyed.

The above summary of the invention does not enumerate all necessary characteristics of the present invention. The subcombinations of these characteristics may also embody the invention.

The best mode for carrying out the invention will now be described.

Although the present invention will be described with reference to embodiments, the following embodiments do not limit the invention according to the scope of claims. Not all combinations of characteristics described in the embodiments are necessary for solving means of the invention.

### BRIEF DESCRIPTION OF THE DRAWINGS

FIG. 1 is a perspective view showing the appearance of an ink jet recording apparatus 100 from the front.

FIG. 2 is a perspective view showing the appearance of the ink jet recording apparatus 100 from the rear.

FIG. 3 is a perspective view showing the internal mechanism 200 of the ink jet recording apparatus 100.

FIG. 4 is an enlarged view of the recording head assembly 230.

FIG. 5 schematically shows a structure of the recording head assembly 230.

FIG. 6 schematically shows a detailed structure of the ultraviolet irradiation head 320.

FIG. 7 schematically shows another structure of the ultraviolet irradiation head 320.

FIG. 8 schematically shows still another structure of the ultraviolet irradiation head 320.

FIG. 9 details part of the ultraviolet irradiation head 320 to show another modification of a recording apparatus including a vibrating section that rocks at least part of the ultraviolet irradiation head 320.

FIG. 10 details part of the ultraviolet irradiation head 320 to show a modification of the ultraviolet irradiation head 320 shown in FIG. 5

FIGS. 11A-11B detail part of the ultraviolet irradiation head 320 to show another modification of the ultraviolet irradiation head 320 shown in FIG. 10. FIG. 11B is a side view from the direction A of FIG. 11A.

FIG. 12 schematically shows another structure of the recording head assembly 230.

### DETAILED DESCRIPTION OF THE DRAWINGS

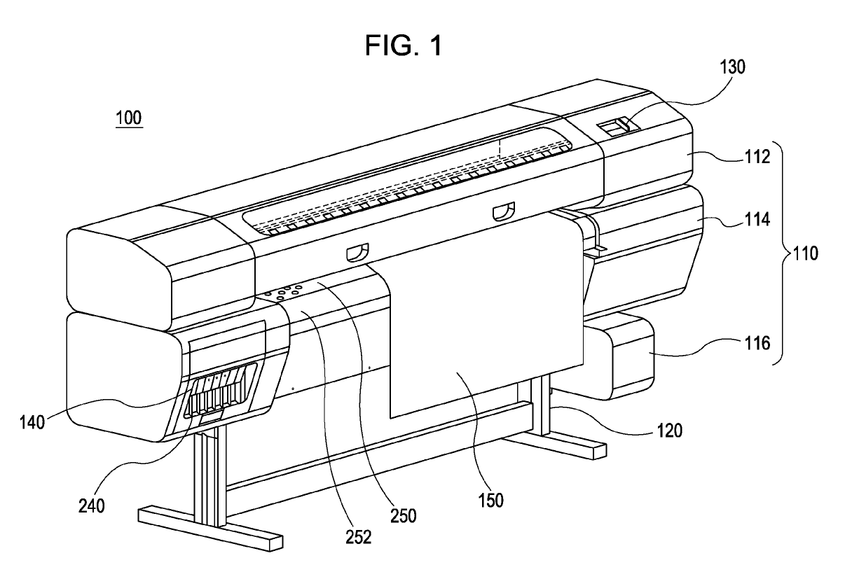

FIG. 1 is a perspective view showing the appearance of an ink jet recording apparatus 100 according to an embodiment. This ink jet recording apparatus 100 discharges ink onto, for example, a large single sheet of A0 or B0 size according to JIS (Japanese Industrial Standards) or roll paper having the same width as such a single sheet, thereby perform printing. Instead of paper, for example, a resin film may be used as a recording medium.

As shown in the figure, the ink jet recording apparatus 100 has a case 110 that includes an upper case 112 and a lower case 114, one of which is put on top of the other, and a small case 116 hung under the lower case 114. The case 110 is lifted and supported by a leg portion 120 from below. Thus, a space to which recorded recording paper 150 is discharged is formed below the case 110.

The upper case 112 is provided with an operation panel 130, which is used when this ink jet recording apparatus 100 is operated in a stand-alone mode. The operation panel 130 may be provided with a display panel, a display lamp, and so forth showing the operating condition of the ink jet recording apparatus 100. On the other hand, the lower case 114 is provided with a cartridge holder 140 into which an ink cartridge 240 containing ink is loaded.

In this ink jet recording apparatus 100, the recording paper 150 on which an image is recorded is advanced from between the upper case 112 and the lower case 114. The advanced recording paper 150 hangs under its own weight. For this reason, a smooth guide surface 252 that smoothly guides the recording paper 150 is formed at the front end of a suction platen 250 visible in the gap between the upper case 112 and the lower case 114.

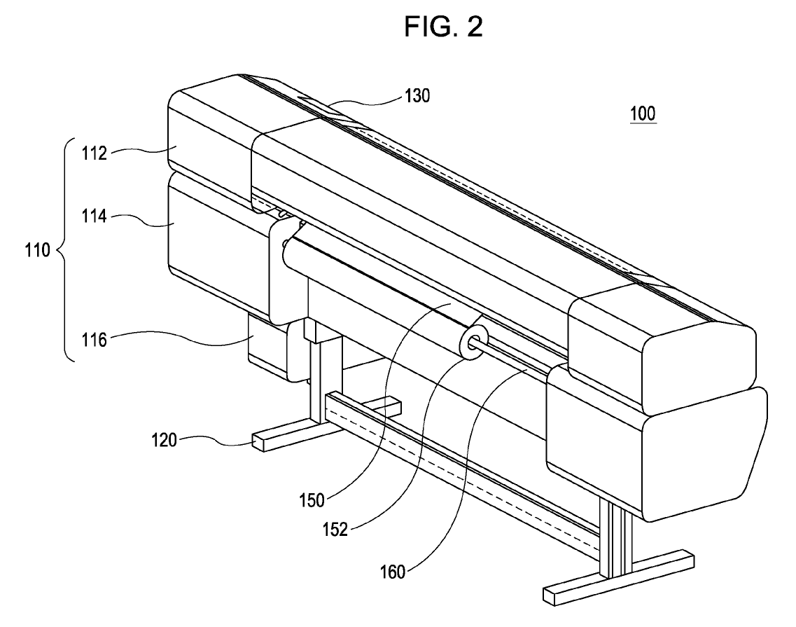

FIG. 2 is a perspective view of the ink jet recording apparatus 100 from the rear. As shown in the figure, in the rear of the ink jet recording apparatus 100, a spindle 160 arranged horizontally and a roll 152 through which the spindle 160 is passed and that is supported horizontally are attached to the rear of the lower case 114. The roll 152 is formed by rolling a long sheet of recording paper 150. The recording paper 150 shown in FIG. 1 corresponds to the front end of the recording paper 150 that is pulled out of the roll 152, passed through the inside of the case 110, and then brought to the front.

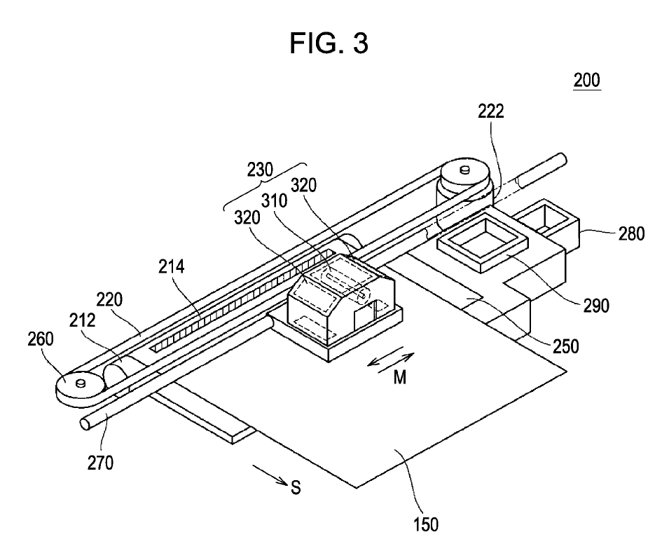

FIG. 3 is a perspective view schematically showing the internal mechanism 200 of the ink jet recording apparatus 100. As shown in the figure, the internal mechanism 200 includes a guide shaft 270, a recording head assembly 230, and the suction platen 250.

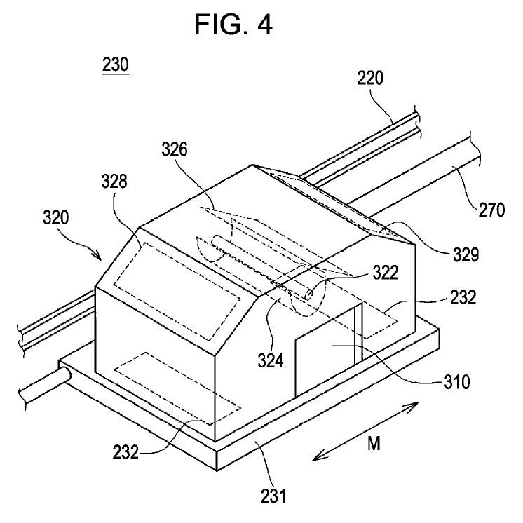

The guide shaft 270 extends parallel to the reciprocation direction M and horizontally in the ink jet recording apparatus 100. On the other hand, the recording head assembly 230 includes a carriage 231 through which the guide shaft 270 is passed, a recording head 310 mounted on the carriage 231, and an ultraviolet irradiation head 320 covering the top and sides of the recording head 310. The carriage 231, through which the guide shaft 270 is passed, reciprocates along the guide shaft 270 in the reciprocation direction M. The detailed structure of the recording head assembly 230 will hereinafter be described with reference to FIG. 4.

Behind the guide shaft 270 is disposed a timing belt 220, which is passed over a pair of pulleys 260. One of the pulleys 260 is rotationally driven by a carriage motor 222. Thus, between the pulleys 260, the timing belt 220 moves parallel to the guide shaft 270.

Part of the timing belt 220 is joined to the recording head assembly 230. Thus, the movement of the recording head assembly 230 can be controlled using drive signals supplied to the carriage motor 222.

In addition, a linear scale 214 is disposed parallel to the reciprocation direction M. The linear scale 214 has a transparent support and light shielding bands formed on the support at regular intervals in the reciprocation direction M. On the other hand, the recording head assembly 230 is provided with a detection section that detects and counts the light shielding bands. Thus, the moving distance of the recording head assembly 230 is accurately detected. The guide shaft 270, the recording head assembly 230, the timing belt 220, and the linear scale 214 are housed in the upper case 112.

Below the moving range of the recording head assembly 230, along the transport direction S of the recording paper 150, a transport section including a transport drive roller 212 and the suction platen 250 are disposed in this order. The transport drive roller 212 and the suction platen 250 are housed in the lower case.

The transport drive roller 212 is rotationally driven by a transport motor and rotates while a transport driven roller (not shown) presses the recording paper 150 against it. Thus, the recording paper 150 is pulled out of the roll 152 and fed onto the suction platen 250.

The suction platen 250 supports the recording paper 150 fed from the transport section, from below. In addition, the suction platen 250 has many suction ports formed in the surface thereof and communicating with a depressurization source such as a suction fan, and attracts the supported recording paper 150. Thus, the suction platen 250 flatly supports the recording paper 150 below the recording head 310 even when the recording paper 150 is curled.

Moreover, on the outer side of the suction platen 250 in the moving direction of the recording head assembly 230, a flushing section 290 and a cap 280 are disposed in series. When flushing, in which a large amount of ink is discharged from the recording head 310, is performed, the flushing section 290 absorbs the discharged ink. By such flushing, thickened ink can be removed from the recording head 310.

When the ink jet recording apparatus 100 is out of operation, the cap 280 hermetically seals the underside of the recording head 310. Thus, ink can be prevented from thickening or solidifying in the recording head 310.

The ink jet recording apparatus 100, which has the above structure, performs a recording operation as follows. First, the transport drive roller 212 feeds the recording paper 150 onto the suction platen 250, and the suction platen 250 flatly holds the transported recording paper 150.

The recording head 310 discharges ink onto the surface of the recording paper 150 while moving in the reciprocation direction M over the recording paper 150 supported on the suction platen 250. The ink jet recording apparatus 100 alternates between an operation in which the transport section 210 transports the recording paper 150 in the transport direction S and an operation in which the recording head 310 reciprocates over the recording paper 150 in the reciprocation direction M, thereby attaching ink to any region on the surface of the recording paper 150 to form an image.

As described below, just after ultraviolet curable ink is attached to the recording paper 150, ultraviolet light emitted from the ultraviolet irradiation head 320 is applied to the ultraviolet curable ink attached to the recording paper 150. Thus, the ultraviolet curable ink is hardened, and an image is fixed on the surface of the recording paper 150.

FIG. 4 schematically shows the structure of the ultraviolet irradiation head 320 of the ink jet recording apparatus 100. As shown in the figure, the recording head assembly 230 includes the recording head 310, the ultraviolet irradiation head 320 formed along the sides in the reciprocation direction M and top of the recording head 310, and the carriage 231 on which the recording head 310 and the ultraviolet irradiation head 320 are mounted.

The recording head 310 has nozzles discharging ultraviolet curable ink in the undersurface thereof. On the other hand, the ultraviolet irradiation head 320 has a discharge tube 322, an elliptic reflecting mirror 324, a movable plane reflecting mirror 326, and stationary plane reflecting mirrors 328 and 329. The recording head 310 and the ultraviolet irradiation head 320 are integrally mounted on the carriage 231, and reciprocate along the guide shaft 270 together with the carriage 231 in the reciprocation direction M.

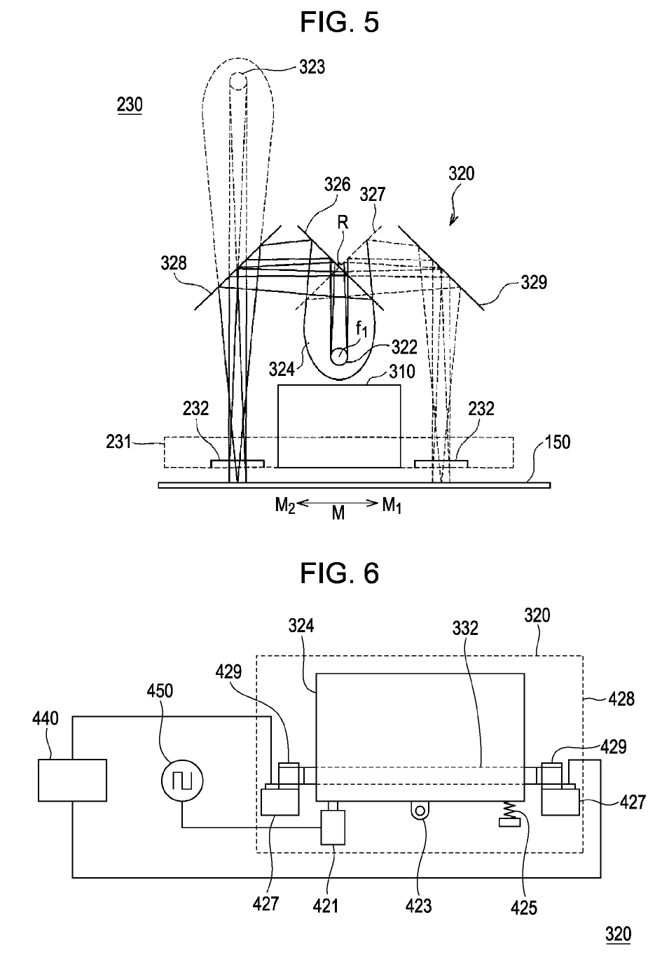

FIG. 5 schematically shows a functional structure of the above recording head assembly 230. As shown in the figure, the discharge tube 322 is disposed over the recording head 310, and it radiates ultraviolet light when supplied with drive power. The elliptic reflecting mirror 324 is disposed in such a manner that the discharge tube 322 is located at one of the focal points thereof, and focuses the ultraviolet light radiated from the discharge tube 322 and guides it in a given direction. In the case of this embodiment, the elliptic reflecting mirror 324 guides ultraviolet light upward and irradiates the movable plane reflecting mirror 326.

The movable plane reflecting mirror 326 rotates around an axis R perpendicular to the paper plane to convert the optical path of ultraviolet light from below into a forward or backward horizontal optical path in the reciprocation direction M. On the horizontal optical path are disposed the inclined stationary plane reflecting mirrors 328 and 329, which convert the horizontal optical path of ultraviolet light into a downward optical path.

That is, when the recording head assembly 230 moves in the moving direction M₁ shown in the figure, the movable plane reflecting mirror 326 is set to the inclination shown in full line in the figure. Thus, the ultraviolet light radiated from the discharge tube 322 is guided to the stationary plane reflecting mirror 328 located behind in the moving direction M₁, and is applied to the recording paper 150 just behind the recording head 310 that moves while discharging ultraviolet curable ink. This is equivalent to the application of ultraviolet light from a virtual light source 323 considered located above and just behind the recording head 310, and hardens the ultraviolet curable ink on the recording paper 150.

On the other hand, when the recording head assembly 230 moves in the moving direction M₂ shown in the figure, the movable plane reflecting mirror 326 is set to the inclination shown in dashed line 327 in the figure. Thus, the ultraviolet light radiated from the discharge tube 322 is guided to the stationary plane reflecting mirror 329 located behind in the moving direction M₂, and is applied to the recording paper 150 just behind the recording head 310 that moves while discharging ultraviolet curable ink. As a result, the ultraviolet curable ink just discharged from the recording head 310 onto the recording paper 150 is hardened.

When the recording head assembly 230 changes its moving direction, the inclination of the movable plane reflecting mirror 326 is set in such a manner that the cap 280 is not irradiated with the ultraviolet light radiated from the discharge tube 322. For example, when the recording head assembly 230 moving in the moving direction M₁ reaches the right-hand turning point and starts to move in the opposite moving direction M₂, the movable plane reflecting mirror 326 is set at such a position that the mirror surface is horizontal. When the recording head assembly 230 reaches such a position that it irradiates the right-hand edge of the recording paper 150, the movable plane reflecting mirror 326 is set to the inclination shown in dashed line 327. Thus, the ultraviolet curable ink remaining in the cap 280 can be prevented from curing in the cap 280.

When the recording head assembly 230 moves in the moving direction M₂ and reaches the right-hand turning point, the movable plane reflecting mirror 326 is set similarly.

In each case, ultraviolet light is applied to the recording paper 150 through an infrared filter 232. This blocks long-wavelength rays in the light output from the discharge tube 322, thereby preventing the temperature increase of the recording paper 150. The ultraviolet light radiated from the discharge tube 322 generates ultraviolet light including all bands capable of hardening all kinds of ultraviolet curable inks discharged from the recording head 310.

An ultraviolet lamp, such as a metal halide lamp, a xenon lamp, a carbon-arc lamp, a chemical lamp, a low-pressure mercury lamp, or a high-pressure mercury lamp, can be used as the discharge tube 322. Ultraviolet light sources are not limited to a discharge tube 322, and other ultraviolet light sources such as an ultraviolet-emitting diode can also be used. On the other hand, the elliptic reflecting mirror 324, the movable plane reflecting mirror 326, and the stationary plane reflecting mirrors 328 and 329 can be formed of an aluminum plate having a mirrored surface. Thus, lightweight reflecting mirrors with high reflective efficiency of ultraviolet light can be obtained.

As described above, the ink jet recording apparatus 100 can apply ultraviolet light using a single discharge tube 322 serving as an ultraviolet light source just in front of or just behind the recording head 310 in both of the reciprocation directions M. Since separate discharge tubes 322 need not be mounted for each of the forward movement and the backward movement, the mass and size of the recording head assembly 230 can be reduced. Thus, the drive mechanism to move the recording head assembly 230 can also downsized. In addition, by reducing the number of discharge tubes 322, for example, the power source for discharge tubes can also be downsized, so the apparatus size of the whole ink jet recording apparatus 100 can be reduced.

Moreover, by reducing the number of components, the production cost of the ink jet recording apparatus 100 can also be reduced. In particular, since discharge tubes, ultraviolet-emitting diodes, and so forth serving as ultraviolet light sources are expensive components, reducing the number of discharge tubes contributes significantly to cost reduction. Furthermore, since a single ultraviolet light source is used in both the forward and backward movements of the recording head assembly 230, the use efficiency of electric power input into the ultraviolet light source is also high.

In addition, the above recording apparatus may include a vibrating section that rocks at least part of the ultraviolet irradiation head 320. The vibrating section includes an actuator 421, a rotatably supporting portion 423, and an elastic member 425.

FIG. 6 schematically shows a detailed structure of the ultraviolet irradiation head 320 including a vibrating section. As shown in the figure, in the ultraviolet irradiation head 320, the discharge tube 322 is supported by electrodes 429, each of which is fixed to a case 428 with an insulating member 427 therebetween. So, the discharge tube 322 is fixed to the case 428. The electrodes 429 are electrically connected to a discharge power source 440.

On the other hand, the elliptic reflecting mirror 324 is rotatably supported, in the middle thereof in the width direction in the figure, at the rotatably supporting portion 423 by the case 428. Thus, the elliptic reflecting mirror 324 rocks around the rotatably supporting portion 423 relative to the case 428.

Moreover, on the upper edge of the elliptic reflecting mirror 324, the elastic member 425 is joined to one end, and one end of the actuator 421 is joined to the other end. The other end of the elastic member 425 and the other end of the actuator 421 are joined to the case 428. In addition, the actuator 421 is electrically connected to the actuator drive power source 450.

The actuator 421, supplied with periodically-varying drive power from the actuator drive power source 450, periodically expands and contracts. Thus, the elliptic reflecting mirror 324 periodically rocks around the rotatably supporting portion 423. A solenoid, or an actuator using a piezoelectric element can be used as the actuator 421.

The elastic member 425 can control the residual vibration of the rocking elliptic reflecting mirror 324. In addition, it can eliminate the tolerance of the rotatably supporting portion 423 by urging the elliptic reflecting mirror 324 in a particular direction.

The discharge tube 322, supplied with a voltage from the discharge power source 440, emits ultraviolet light. Most of the ultraviolet light radiated from the discharge tube 322 is reflected by the elliptic reflecting mirror 324 and is then directed upward in the figure. So, when the elliptic reflecting mirror 324 rocks, the direction of reflected light also changes.

In the discharge tube 322, stationary striation, moving striation, and so forth can be generated along the discharge path. In addition, both ends of a quartz tube forming a discharge path are deformed to attach caps thereto. Due to these causes, the ultraviolet light that the discharge tube 322 radiates has an intensity distribution in the longitudinal direction of the discharge tube 322. However, as described above, when the elliptic reflecting mirror 324 periodically rocks, the direction of reflected light is also displaced in the longitudinal direction of the discharge tube 322. Thus, the intensity distribution is diffused, and the recording paper 150 is irradiated with ultraviolet light having a uniform intensity.

The vibration period of the elliptic reflecting mirror 324 is, for example, at least about the same as the power source frequency of the discharge power source 440, and specifically, at least 50 Hz or 60 Hz. When the amplitude of vibration is at least several millimeters, and more specifically, at least 4 mm on the reflecting surface of the elliptic reflecting mirror 324, the irradiation intensity distribution can be sufficiently uniformized.

FIG. 7 schematically shows another structure of the ultraviolet irradiation head 320. The structure is, except for the parts described below, the same as the ultraviolet irradiation head 320 shown in FIG. 6, so the same reference numerals will be used to designate the same components and redundant description will be omitted.

As shown in the figure, in this ultraviolet irradiation head 320, compared to the ultraviolet irradiation head 320 shown in FIG. 6, the positions of the rotatably supporting portion 423 and the elastic member 425 are reversed. Thus, the distance between the rotatably supporting portion 423 and the actuator 421 is increased, and the elliptic reflecting mirror 324 can be rocked with a low-power actuator 421.

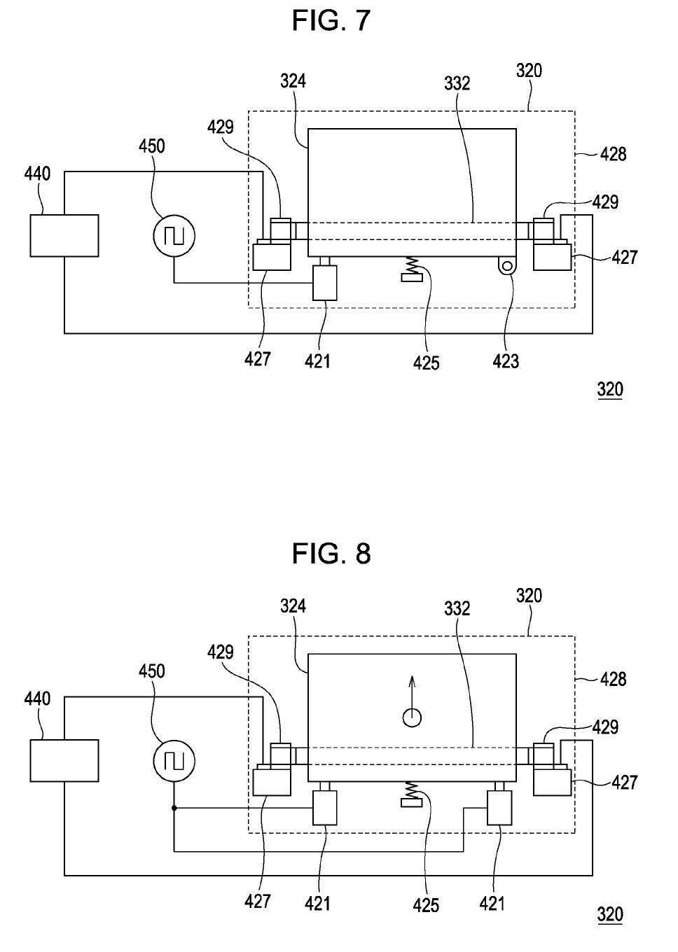

FIG. 8 schematically shows still another structure of the ultraviolet irradiation head 320. The structure is, except for the parts described below, the same as the ultraviolet irradiation heads 320 shown in FIGS. 6 and 7, so the same reference numerals will be used to designate the same components and redundant description will be omitted.

As shown in the figure, in this ultraviolet irradiation head 320, both ends of the upper edge of the elliptic reflecting mirror 324 are joined to a pair of actuators 421. In addition, the elliptic reflecting mirror 324 is supported by the actuators 421 from below, and the rotatably supporting portion 423 is omitted. The location of the elastic member 425 is the same as in the ultraviolet irradiation head 320 shown in FIG. 7.

The pair of actuators 421 are opposite in polarity to each other. So, when they are supplied with a common drive power from the actuator drive power source 450, one expands and the other contracts. Due to such a structure, the axis of rocking of the elliptic reflecting mirror 324 is virtually formed inside the elliptic reflecting mirror 324.

By placing this virtual rocking axis at the center of gravity G of the elliptic reflecting mirror 324, the displacement of the center of gravity of the elliptic reflecting mirror 324 accompanying rocking can be eliminated. Thus, the load on the actuators 421 can be reduced, and the vibration accompanying the rocking of the elliptic reflecting mirror 324 can be controlled.

As described above, in the ultraviolet irradiation head 320, the intensity distribution is made uniform by vibrating the elliptic reflecting mirror 324. So, when this ultraviolet irradiation head 320 is mounted in a recording apparatus using ultraviolet curable ink, ultraviolet curable ink can be uniformly hardened and recording quality can be improved. In addition, since the power input from the discharge power source can be made to efficiently contribute to hardening without waste, the power consumption of the recording apparatus can be reduced.

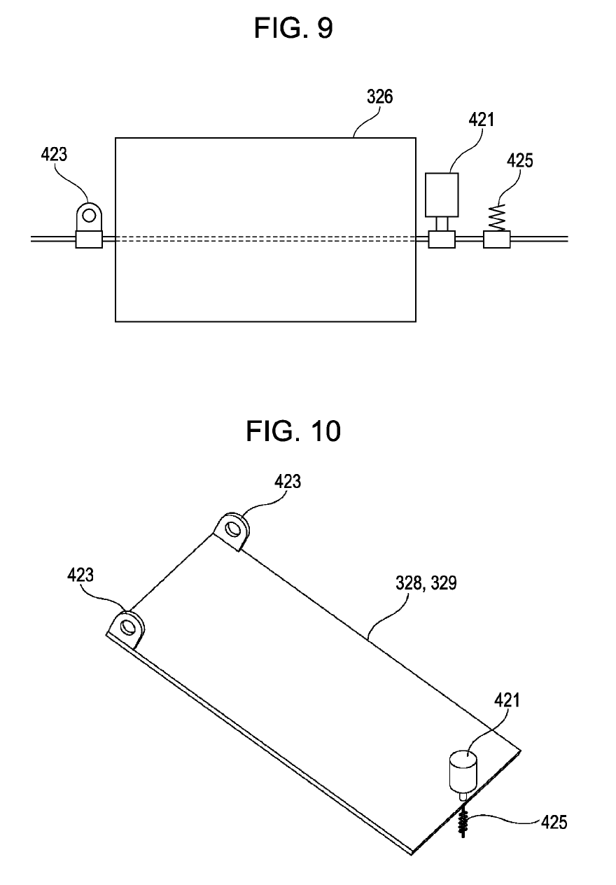

FIG. 9 details part of the ultraviolet irradiation head 320 to show another modification of a recording apparatus including a vibrating section that rocks at least part of the ultraviolet irradiation head 320. The ultraviolet irradiation head 320 has an actuator 421, a rotatably supporting portion 423, and an elastic member 425.

One end of each of the actuator 421, rotatably supporting portion 423, and elastic member 425 is joined to a shaft R of the first plane reflecting plate 326 rotatably relative to the shaft R. The other end of each of the actuator 421, rotatably supporting portion 423, and elastic member 425 is joined to the case 428. Due to such a configuration, the movable plane reflecting mirror 326 rocks around the rotatably supporting portion 423 relative to the case 428. Thus, the intensity of ultraviolet light that the ultraviolet irradiation head radiates can be uniformized.

FIG. 10 details part of the ultraviolet irradiation head 320 to show a modification of the ultraviolet irradiation head 320 shown in FIG. 5. One end of each of an actuator 421, rotatably supporting portions 423, and elastic member 425 is joined to the stationary plane reflecting mirror 328, and the other end of each of the actuator 421, rotatably supporting portions 423, and elastic member 425 is joined to the case 428. The actuator 421 expands and contracts, thereby rocking the stationary plane reflecting mirror 328 around the rotatably supporting portions 423 relative to the case 428. Thus, the intensity of ultraviolet light that the ultraviolet irradiation head radiates can be uniformized.

The “stationary” of the stationary plane reflecting mirror 329 means that whereas the movable plane reflecting mirror 328 rotates to switch between ultraviolet light paths at the time of switching between the forward and backward movements, the stationary plane reflecting mirror 329 is not moved for switching between ultraviolet light paths. So, the stationary plane reflecting mirror 329 is disposed so as to be able to rock for uniformizing the intensity in the ultraviolet irradiation head 320.

The stationary plane reflecting mirror 329 (corresponding to “backward reflecting plate” in the claims when the movement in the moving direction M₂ is referred to as backward) as well as the stationary plane reflecting mirror 328 may also be rocked so as to uniformize the intensity of ultraviolet light that the ultraviolet irradiation head radiates.

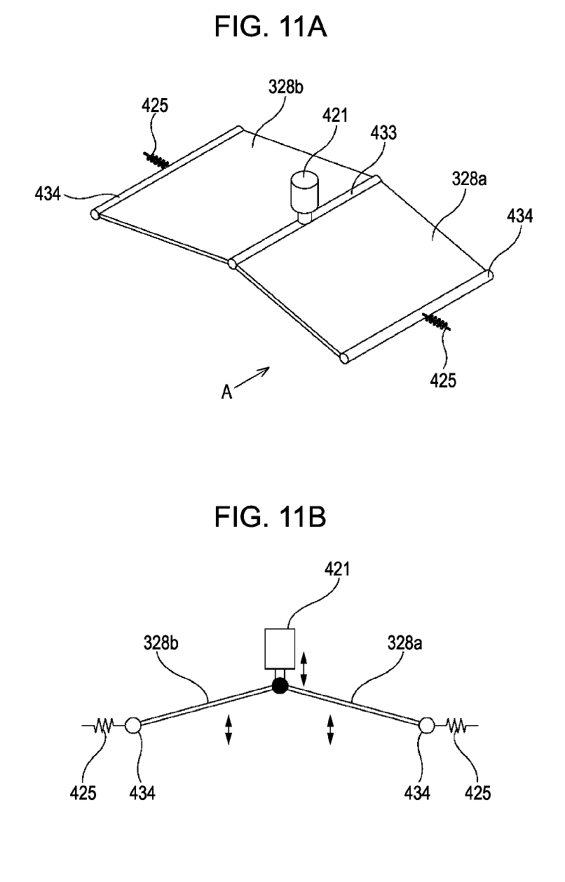

FIG. 11A details part of the ultraviolet irradiation head 320 to show another modification of the ultraviolet irradiation head 320 shown in FIG. 10. FIG. 10B is a side view from the direction A of FIG. 11A. As shown in both figures, the stationary plane reflecting mirror 328 has a plurality of plane reflecting mirrors (two mirrors 328a and 328b in the example of FIG. 11). To a side of the stationary plane reflecting mirror 328 is attached a connecting shaft 433 that rotatably connects the stationary plane reflecting mirrors 328a and 328b. To other sides are connected support shafts 434. To the connecting shaft 433 is attached one end of an actuator 421. To each of the support shafts 434 is attached one end of an elastic member 425. The other end of each of the actuator 421 and elastic members 425 is joined to the case 428.

The actuator 421 expands and contracts, thereby rocking the stationary plane reflecting mirrors 328a and 328b around the connecting shaft 433 relative to the case 428. Thus, the irradiation direction of ultraviolet light reflected by the edges of the stationary plane reflecting mirror 328 can be prevented from being excessively diffused, and the intensity of ultraviolet light that the ultraviolet irradiation head radiates can be uniformized.

The stationary plane reflecting mirror 329 may also have a plurality of plane reflecting mirrors and be rocked like the stationary plane reflecting mirror 328 so as to uniformize the intensity of ultraviolet light that the ultraviolet irradiation head radiates.

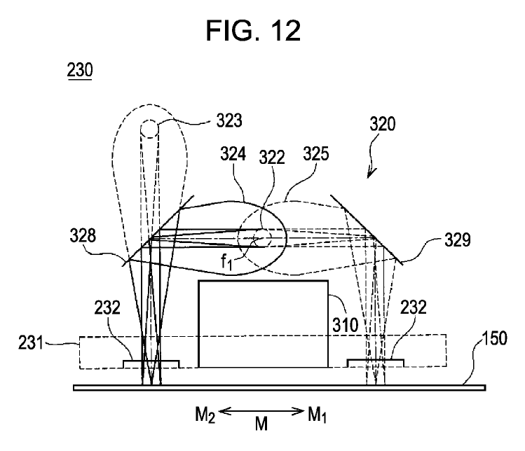

FIG. 12 schematically shows the structure of a recording head assembly 230 according to another embodiment. Except for the following respects, this recording head assembly 230 has the same structure as the recording head assembly 230 shown in FIG. 5. So, the same reference numerals will be used to designate the same components and redundant description will be omitted.

As shown in the figure, in this ultraviolet irradiation head 320, an elliptic reflecting mirror 324 that guides the ultraviolet light output from a discharge tube 322 rotates around one of the focal points thereof. Thus, the direction of ultraviolet light output from the elliptic reflecting mirror can be changed, so the movable plane reflecting mirror 326 can be omitted. The discharge tube 322 is located at one of the focal points of the elliptic reflecting mirror 324, so the size and intensity of the beam of ultraviolet light output from the elliptic reflecting mirror 324 do not change regardless of the direction of the elliptic reflecting mirror 324. The ultraviolet light output from the elliptic reflecting mirror 324 horizontally propagates forward or backward in the reciprocation direction M and is then directed downward by a stationary plane reflecting mirror 328 or 329.

When the recording head assembly 230 moves in the moving direction M₁ shown in the figure, the elliptic reflecting mirror 324 opens, as shown in full line in the figure, toward the stationary plane reflecting mirror 328 located behind in the moving direction M₁. So, the ultraviolet light radiated from the discharge tube 322 is reflected by the stationary plane reflecting mirror 328 and is applied to the recording paper 150 just behind the recording head 310 that moves while discharging ultraviolet curable ink.

On the other hand, when the recording head assembly 230 moves in the moving direction M₂ shown in the figure, the elliptic reflecting mirror 324 rotates 180 degrees and opens, as shown in dashed line 325 in the figure, toward the stationary plane reflecting mirror 329 located behind in the moving direction M₂. So, the ultraviolet light radiated from the discharge tube 322 is reflected by the stationary plane reflecting mirror 329 and is applied to the recording paper 150 just behind the recording head 310 that moves while discharging ultraviolet curable ink. Thus, the number of components of the ink jet recording apparatus 100 is further reduced, and the mass and size of the recording head assembly 230 is further reduced.

In addition, the above recording apparatus may include a vibrating section that rocks at least part of the ultraviolet irradiation head 320. That is, by rocking the elliptic reflecting mirror 324 or the stationary plane reflecting mirrors 328 and 329, the vibrating section can uniformize the intensity of ultraviolet light that the ultraviolet irradiation head applies. Specific configurations in the case where the elliptic reflecting mirror 324 is rocked are the same as those shown in FIGS. 6 to 8, and specific configurations in the case where the stationary plane reflecting mirrors 328 and 329 are rocked are the same as those shown in FIGS. 10 to 11, so detailed descriptions thereof will be omitted.

Although the present invention has been described with reference to embodiments, the technical scope of the present invention is not limited to the above embodiments. It is apparent to those skilled in the art that various changes or modifications may be made in the above embodiments. In addition, it is apparent from the claims that such modified or improved embodiments may also be included in the technical scope of the present invention.

What is claimed is:

1. A recording apparatus comprising:
a recording head that reciprocates along the surface of a recording medium and discharges ultraviolet curable ink toward the recording medium;
an ultraviolet light source that moves together with the recording head and outputs ultraviolet light; and
a light path switching section that switches between two light paths through which ultraviolet light from the ultraviolet light source is applied in front of and behind the recording head in the reciprocation direction.

2. The recording apparatus according to claim 1, wherein the light path switching section includes a plane reflecting mirror that changes the propagation direction of output light of the ultraviolet light source by rotating around an axis perpendicular to the reciprocation direction.

3. The recording apparatus according to claim 2, further comprising a vibrating section that rocks at least part of the light path switching section.

4. The recording apparatus according to claim 2, wherein the light path switching section include a forward reflecting mirror that follows the recording head in the forward movement of the reciprocation and guides ultraviolet light toward the ultraviolet curable ink attached to the recording medium, a backward reflecting mirror that follows the recording head in the backward movement of the reciprocation and guides ultraviolet light toward the ultraviolet curable ink attached to the recording medium, and a vibrating section that rocks at least one of the forward reflecting mirror and the backward reflecting mirror.

5. The recording apparatus according to claim 1, wherein the light path switching section includes an elliptic reflecting mirror that has an elliptic arc cross-sectional shape, that is disposed in such a manner that the ultraviolet light source is located at one of the focal points, thereby converging the output light of the ultraviolet light source, and that rotates around an axis passing through said one of the focal points, thereby outputting the output light of the ultraviolet light source in different directions.

6. The recording apparatus according to claim 5, further comprising a vibrating section that rocks at least part of the light path switching section.

7. The recording apparatus according to claim 5, wherein the light path switching section include a forward reflecting mirror that follows the recording head in the forward movement of the reciprocation and guides ultraviolet light toward the ultraviolet curable ink attached to the recording medium, a backward reflecting mirror that follows the recording head in the backward movement of the reciprocation and guides ultraviolet light toward the ultraviolet curable ink attached to the recording medium, and a vibrating section that rocks at least one of the forward reflecting mirror and the backward reflecting mirror.

8. The recording apparatus according to claim 1, wherein the two light paths include a forward ultraviolet light path that follows the recording head in the forward movement of the reciprocation and guides ultraviolet light toward the ultraviolet curable ink attached to the recording medium, and a backward ultraviolet light path that follows the recording head in the backward movement of the reciprocation and guides ultraviolet light toward the ultraviolet curable ink attached to the recording medium, and wherein the light path switching section inputs the output light of the ultraviolet light source onto the forward ultraviolet light path or the backward ultraviolet light path.

9. The recording apparatus according to claim 1, further comprising a vibrating section that rocks at least part of the light path switching section.

10. The recording apparatus according to claim 9, wherein the vibrating section includes a linear actuator that linearly displaces part of the reflecting mirror rotatably supported at another part thereof.

11. The recording apparatus according to claim 5, further comprising a vibrating section that periodically displaces parallel to an optical axis plane of the reflecting surface of the elliptic reflecting mirror, thereby rocking the elliptic reflecting mirror, at least part of the elliptic reflecting mirror, around an axis perpendicular to the optical axis plane.

12. The recording apparatus according to claim 11, wherein the vibrating section includes a linear actuator that linearly displaces part of the reflecting mirror rotatably supported at another part thereof.

13. The recording apparatus according to claim 1, wherein the light path switching section includes an aluminum plate having a mirrored surface.

14. The recording apparatus according to claim 9, wherein the elliptic reflecting mirror is rotatably supported around an axis that is a straight line passing through the center of gravity of the elliptic reflecting mirror, and the vibrating section rocks the elliptic reflecting mirror around the axis.

15. The recording apparatus according to claim 1, wherein the light path switching section include a forward reflecting mirror that follows the recording head in the forward movement of the reciprocation and guides ultraviolet light toward the ultraviolet curable ink attached to the recording medium, a backward reflecting mirror that follows the recording head in the backward movement of the reciprocation and guides ultraviolet light toward the ultraviolet curable ink attached to the recording medium, and a vibrating section that rocks at least one of the forward reflecting mirror and the backward reflecting mirror.

16. A liquid ejecting apparatus comprising:
a liquid ejecting head that reciprocates along the surface of an ejecting medium and discharges liquid including ultraviolet curable resin toward the ejecting medium;
an ultraviolet light source that moves together with the liquid ejecting head and outputs ultraviolet light; and
a light path switching section that switches between two light paths through which ultraviolet light from the ultraviolet light source is applied in front of and behind the liquid ejecting head in the reciprocation direction.
